(19) United States
(12) Patent Application Publication
(10) Pub. No.: US 2005/0218077 A1
(43) Pub. Date: Oct. 6, 2005

(54) Method for processing hydrolasing wastewater and for recycling water

(76) Inventor: Dennis A. Brunsell, Knoxville, TN (US)

Correspondence Address: MONROE ALEX BROWN, P. O. BOX 70501, KNOXVILLE, TN, 37938-0501, US

(21) Appl. No.: 11/091,308

(22) Filed: Mar. 28, 2005

Related U.S. Application Data
(60) Provisional application No. 60/558,826, filed on Apr. 3, 2004.

(51) Int. Cl. B01D 61/00

(52) U.S. Cl. 210/650; 210/805; 210/806

(57) ABSTRACT

The invention relates to the process, method and system of treating, processing and recycling wastewater generated from a hydrolasing process, or similar operation, equipment utilization or cleaning project, utilizing amounts of water as a part of such a process. The invention is used for the purpose among others of greatly improving the cost and re-usability of water volumes. The method includes the subprocesses of wastewater conveyance or communication; separation of particulate matter; polishing filter or backwashable candle filter wastewater treatment; and removal of remaining dissolved solids/organics, producing a recyclable feed end product; and conveyance for recyclable use. Many different types of equipment can be utilized in the subprocesses of the invention.

### RELATED APPLICATION

This present non-provisional patent application claims the benefit of the filing date of the earlier provisional patent application filed on Apr. 3, 2004, Application No. 60/558,826; said provisional application being incorporated by reference, in its entirety, herein.

### BACKGROUND OF THE INVENTION

1. Field of the Invention

The present invention relates to the process of treating, processing and recycling wastewater generated from a hydrolasing process, or similar operation.

2. Background Information

In this technology, high-pressure hydrolasing has become one of the most cost effective and environmentally supportive means of decontaminating surfaces, especially when used in support of decommissioning activities.

Various types of hydrolasing means have been used in this industry for over 40 years; or since the 1960's. However, the introduction of an ultrahigh-pressure system, coupled with the technology and teachings of the present invention, herein, for recycling the water utilized in the hydrolasing process, now usher forth a new superior level of effectiveness and efficiency, when utilized for surface (i.e., concrete, etc.) decontamination; when compared to any of the past means for accomplishing this.

Basically, in this technology, once a surface has been decontaminated with the use of a ultrahigh-pressure hydrolasing process, the underlying building or other structure can be torn down and disposed of as non-contaminated rubble, etc.; greatly reducing disposal cost in relation to past methods or means.

Importantly, the referenced hydrolasing process generates in such activities from about one (1) to about two (2) million gallons of wastewater for every million square feet of surface area hydrolased. Without water recycling the expense of processing this wastewater would be prohibitive. In one such project the cost of water treatment, including transportation, was estimated to about $17.00 per gallon. However, when this water was processed and recycled as provided in the teachings of the present invention, a few thousand gallons was found therein to be reusable a number of times, drastically reducing the otherwise anticipated expense.

Briefly, the ultrahigh-pressure water (up to about 55,000 psig) can quickly strip up to ⅜th's inch of paint and 3/8th's inch of concrete in a single pass. Remotely operated hydrolasing equipment walks or moves along floors, walls, ceilings, and special structures. Hydrolasing generates no airborne contamination and eliminates the potential for personnel injury posed by scabblers.

Continual recycling of the process water sharply reduces the amount of water and hence the expense of the overall hydrolasing process, to a few thousand gallons; for example, when decontaminating a building having about 600,000 (six hundred thousand) square feet (ft2) of surface area. This few thousand gallons of water is provided as a product with nearly undetectable levels of contamination. This water can, therefore, be discharged to the environment or used to control dust during building demolition. These types of results, in dealing with comparable surface areas for decontamination and decommissioning have previously been unknown in the prior art.

An example of the type of hydrolasing equipment with which the process of the present invention is designed to interact with, work with and/or enhance; is the VAC TRAX® System; owned, developed and manufactured by TMR Associates, 11575 West 13^{th} Avenue, Lakewood, Colo. 80215. The VAC TRAX® System is a self-contained and automated system that uses supersonic jets of water to remove coatings (e.g., paint) surface and subsurface contamination, and structural material (e.g., concrete). In utilizing this System jets of water strike a target surface with sufficient energy to cause the coatings to fracture and spall without damaging the underlying surface, unless required by the nature of a specific job to remove contamination.

The VAC TRAX® System, therefore, through remote operation of its jetting tool, for safety of workers and site personnel; directs ultrahigh-pressure water to remove coverings from a diverse variety of surfaces; including, but not limited to, concrete/steel walls, floors and ceilings; or other surfacing constructed of other types of materials. For example, the VAC TRAX® System is capable of scarifying concrete and epoxy or other polymer or plastic surfaces so that enhanced deep cleaning is obtained when, for example, embedded contamination such as radioactivity (or various forms thereof) is present or found to be an environmental concern.

In utilizing the VAC TRAX® System, no debris or water escapes into the environment. Instead, such material is vacuumed from the manifold of the VAC TRAX® through a flexible vacuum hose and communicated or transported to a Waste Barrel Containment System. After existing gross solids are removed during passage through the referenced Waste Barrel Containment System, the remaining subject wastewater is directed to the processing method sand system of the present invention for separation of fine and dissolved solids.

However, the present processing method of the present invention can receive various types of wastewater from a diversity of cleaning and decontamination jobs involving the use of many diverse types of equipment and the generation of wastewater having many diverse types of solids dispersed, finely spread, admixed or otherwise present in wastewater or waste fluids; and can provide, through its processing teachings, substantial to astronomical savings in re-processing and recycling water or like fluid volumes such that such volumes can be utilized again-and-again in such cleaning and decontamination jobs; and provide end-process products which are environmentally-friendly and further usable or re-usable in other activities or jobs. These positive characteristics and diversity of use, in providing safety and large saving in terms of time and money provide further advantages over the prior art.

Additionally, the present invention's teachings further distinguish from the known prior art in providing a clarifying and deionizing process or method which involves separating the remaining fine particulates in a wastewater, or similar fluid volume, with a centrifuge means; and, then, polishing the water or fluid volume with a precoat filter. Finally, in this regard, a Reverse Osmosis means is utilized to remove the remaining dissolved solids before the water is returned as recycle feed to the ultrahigh-pressure pumps of equipment such as VAC TRAX®, referenced and described above, for huge savings in the amount of water or fluid necessary for such a job. Underwater hydrolasing is a similar process except that the hydrolasing process is done underwater to minimize radioactive dose or airborne concerns. An example of this would be where such activities are performed in a Fuel Pool.

Further advantages over the prior art include the fact that, in preferred embodiments of the present invention, the water processing operation and method of the invention are designed to process a returned slurry at a generated rate of from about 1 (one) to about 50 gpm. The number of hydrolasing units, with which the present process serves and interacts with, dictates the actual flow rate of the present process. The production rates of hydrolasing units, with which the present process and method have been utilized, are approximately from about 150 ft2 (square feet) to about 400 ft2 per hour when treating floors, from about 120 ft2 to about 280 ft2 per hour for walls, and from about 50 ft2 to about 150 ft2 per hour for ceilings. Beams and corners have been shown to be hydrolased at from about 50 ft2 to about 75 ft2 per hour. It will be understood that these rates, when utilizing hydrolasing equipment can vary depending on the building or other structure to be decontaminate and/or decommissioned; or otherwise the subject of hydrolasing.

Further advantage exists in the fact that a workforce of one or two technicians per shift can monitor, operate and maintain the equipment utilized in augmenting the water processing method of the present invention. Additionally, all of the equipment can be recovered for use on other decontamination and decommissioning projects, resulting in substantial cost savings for multi-project decommissioning projects or work sites.

### BRIEF DESCRIPTION OF THE DRAWINGS

FIG. 1 is a flow chart-oriented drawing illustrating in broad terms the Method and Process of the present invention.

FIG. 2 is a further flow chart-oriented drawing setting forth and illustrating other preferred embodiments, and optional sub-processes of the present process.

FIG. 3 is a more expanded flow chart drawing illustrating, symbolically, other available features of preferred embodiments of the present process, method, system and equipment allocation of the present invention. FIG. 3 is split into subpart drawings: FIGS. 3A, 3B-, 3C, 3D, 3E, 3F and 3G, for clarification and dimensionality purposes.

FIG. 4 is an expanded system flow chart showing a preferred embodiment of the present method and invention; which employs separate, specific letter-numbering for individual equipment members, in addition to previously utilized sub-step-numbering and identification of the invention. FIG. 4 is split into subpart drawings: FIGS. 4A and 4B.

### REFERENCE NUMBERS

10 Method And System For Processing Hydrolasing Wastewater and Recycling Water or Recycle Process or Present Method or Present System
11 Wastewater Feed or Water Volume or Stream
12 Communicating With A Volume or Stored Amount Of Hydrolasing Wastewater or Fluid
14 Separating Of The Particulate From The Wastewater Stream/Volume or The Solid/Liquid Separation, Subprocess or Solid/Liquid Separation, or S/L Separation
14A Centrifuge Means or Centrifuge Equipment
14B Backdrive Unit, Equipment or Means
15 Flow Control Valve and Flow Meters, System or Means
16 Polishing Filter Step or Backwashable Candle Filter Subprocess or Subprocess
16A Bag Filters, or such means, Alternative System (which can be bypassed)
17 Vibrators or Vibration System or Means
18 Removal Of The Total Dissolved Solids/Organics or TDS Removal Step or TDS Removal
18A Reverse Osmosis Unit or Equipment of Step (18)
18B Ion Exchange, System or Means
18C EDI (Electro Deionization)
20 Depositing Solid Waste From Step (14) Into Waste Container (20A)
21 Waste Container For TDS Solids From Solidification (38A) or Evaporation (38B)
22 Feed Tank
24 Separation Chemical Treatment Step
26 Post Gross S/L Separation Chemical Treatment, or the Treatment
26A Floating Suction Means or Decant Alternative Means or System
28 pH and Anti-Scalent Addition or Subprocess
40 Addition Of Chemicals as part of Step (26)
30 concentrate Tank Equipment, or Step in so expediting or functionally bringing about
32 High Pressure RO (Reverse Osmosis), or Step so implementing
34 Post RO Chemical Treatment, or Step
36 Chiller Equipment, System or Means
38
   38A Mixing Process To Convert Concentrate To solids Through Addition Of Solidification Agent
   38B Evaporation Process To Convert Concentrate To Dry Solid Through Evaporation
42 Filter Precoat
48 Addition Of Solidification Agent, or Step For So Doing
50 DI Water Storage Means, Or System, Tank Means or Tank System

### DETAILED DESCRIPTION OF THE PREFERRED EMBODIMENTS OF THE INVENTION

The following description of the preferred embodiments of the concepts and teachings of the present process, method and system, and product therefrom, of the invention is made in reference to the accompanying drawing figures which constitute illustrated schematic examples of the methodical, systematic, process and functional elements of the present invention, among many other examples existing within the scope and spirit of the invention.

Herein, the following Abbreviations are utilized:
DI—de-ionized
EDI—Electro Deionization
F—Fahrenheit
G—gravitation force
MHOS (mhos)—measure of conductivity (reciprocal of ohms)
pH—measure of hydrogen ion concentration in water
RCRA—Resource conservation and Recovery Act
RO—reverse osmosis
S/L—solid/liquid
TDS—total dissolved solids
TSS—total suspended solids
   Use of the word, “augment”, means in its use herein: to facilitate or to be used to bring about or perform a process or subprocess step regarding the present invention.

In its broadest sense, as indicated in part earlier, the clarifying and deionizing process of the present invention involves separating the remaining fine solid particulates with a centrifuge means, then polishing the water with or through a precoat filter means; and, then, a utilizing a reverse osmosis procedure to remove the remaining dissolved solids before the water is returned as recycle feed to the ultrahigh-pressure pumps of a hydrolasing means or similar decontamination equipment or means.

In an overview of one of the embodiments of the process and method of the present invention, a slurry is received from the Waste Barrel Containment System, or directly from underwater hydrolasing operations, previously referenced; which, itself, has received this waste slurry as contaminant materials created as a result of utilizing the hydrolasing means described herein for contamination or decommissioning of a building or other structure. This slurry, so received, will generally contain from about 0.1% (one-tenth of one percent) to about 10% (ten percent) solids at a flow rate of from about 2 gpm (two gallons per minute) to about 12 gpm (twelve gallons per minute) for each hydrolasing head being operated as a part of the overall hydrolasing equipment or means, or 25 to 50 gpm for underwater hydrolasing.

With regard to the Centrifuge subprocess of the present invention, this slurry is directed to the Centrifuge Feed Tank, where initial concentration and pretreatment of solids will occur. This tank is maintained on continuous recycle to prevent solids from settling. A slipstream is fed to the solid bowl centrifuge, where 3,000 rpm (three thousand revolutions per minute) generate centrifugal forces of up to about 2,000 (two thousand) times gravity (2,000G) to enhance the separation of solids from liquid or fluid. The back-drive of the centrifuge operates an internal scroll that drags the solids onto the beach of the centrifuge, where dewatering occurs. The final discharge from the centrifuge drops, by gravity or conveyor, into the waste box. The clarified water overflows a dam at the opposite end of the centrifuge and is pumped to a Water Treatment Tank to be treated before final polishing filtration.

With regard to the Polishing Filter subprocess of the present invention, precoat backwashable filters are utilized as the final polishers in one preferred embodiment of the invention. These precoat backwashable filters protect the Reverse Osmosis subsystem and subprocess, to follow, by providing filtration of particulates or solids down to approximately 0.25 microns. Because hydrolased paint is sticky, these polishing filters require a precoat to prevent the paint from adhering to the filter elements, and provide lower micron-filtration. The precoat is backwashed once or twice daily in the types of jobs used as examples herein; and returned to the Centrifuge Feed Tank for solids removal. In this regard, the secondary waste from these precoats is expected to contribute less than 1% (one percent) of the total project waste volume in the types of projects or jobs set forth by example, only, herein.

Regarding the Reverse Osmosis subprocess or subsystem of the present invention, it is known that some dissolution of solids and radioactive isotopes occurs (in those projects involving this) during the hydrolasing process. Such dissolved solids or materials must be removed before recycle to prevent them from recontaminating newly exposed surfaces and fouling the ultrahigh-pressure system of the hydrolasing means or systems being utilized in interaction with the process of the present invention. The Reverse Osmosis subprocess of the present invention is effective at removing these contaminants and concentrating them into solids waste.

With regard to the Waste box Filling subsystem of the present invention, a B-25 type waste box is placed directly under the centrifuge means utilized in the centrifuge subprocess of the present invention, to catch the dewatered sludge. Though the centrifuge may often meet the dewatering requirements for disposal, a proprietary polyacrylate polymer is added to the box to assure that no free water remains. In preferred embodiments of the process and system of the present invention, a remotely controlled fillhead with internal CCTV allows monitoring of the fill process. Additionally, in preferred embodiments, with regard to an overview of the present invention, a System controls/Design is part and parcel of the concepts and spirit of the present invention. In the this regard, the entire Water Treatment/Recycle System is PLC-controlled; incorporating interlocks and automatic safety shutdowns. Water quality is continuously monitored. A single operator or personnel worker on site can control and monitor the system. In applications where gamma/beta radiation dose is a concern, the system can be operated from a remote low-dose environment or area. Additionally, within the concepts and scope of the present invention, the equipment system utilized as means of actuating the subprocess steps of the present invention, is skid mounted for quick deployment and removal. Also, though one of the principal embodiments of the present invention and system was designed for use in a building, units can be contained in multiple CONEX-type shipping containers for use when building space is not readily available. Further, system interconnections can easily be made or broken in a few days for setup and teardown. The system of the present invention can also be operated on diesel generator power, and is designed within the spirit of the present invention to be self-contained and mobile.

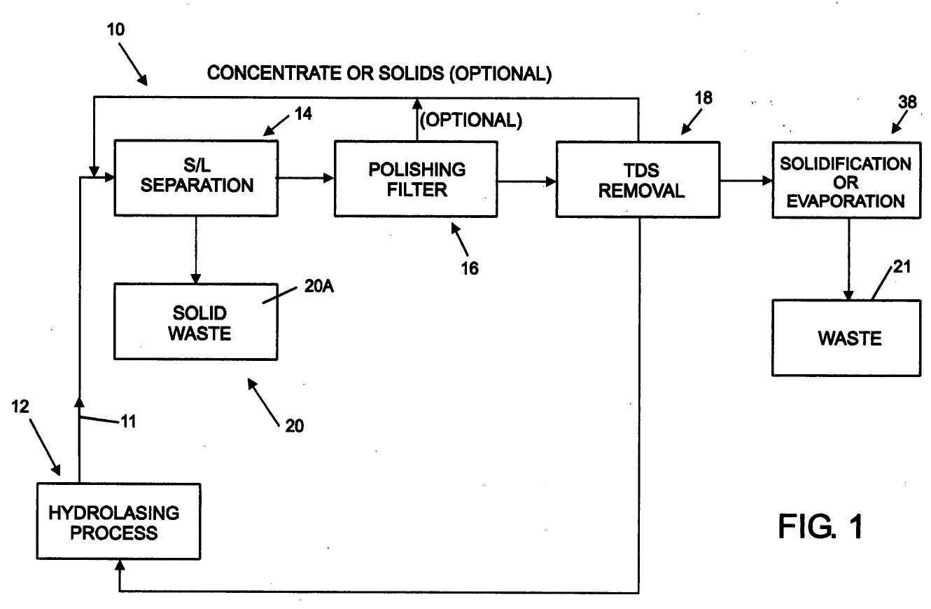

Referring now to the drawings, FIGS. 1, 2 and 3, thereof, there is diagrammatically illustrated A Method And System For Processing Hydrolasing Wastewater and Recycling Water 10, of the present invention referred to hereinafter as the Recycle Process (or Present Method or System) 10.

Wastewater Feed

The Recycle Process is provided with the initiating step of accessing or communicating with a volume or stored amount of hydrolasing or high pressure washing wastewater or wastewater feed (11). It will be understood by those skilled in the art that this communication and transfer means for such wastewater can be accomplished in a number of piping or conduit systems, and/or pump, means. Hydrolasing wastewater (11) contains particulate constituting from about 0.001% to about 10% solids; but typically from about 0.5% to about 2% of such solids. The solids, as indicated in part above herein, are generated from the high pressure water scabbling the surface; and, thereby, releasing sand, paint, coatings, grit and small rocks from the target surfacing. Total Dissolved solids, referenced hereinafter as “TDS”, having from about ppm (parts per million) to about 2500 ppm; and typically (in volumes with which the Present Method 10 interacts) from about 250 ppm to about 1000 ppm; of both ionic and organic components are removed from the target surface coating and dissolution of the substrate. The soluble species may also have dried or precipitated on the surface and is easily dissolved when contacted by water; the high temperature and intimate contact generating high surface area and accelerating dissolution.

Return Water Requirements

The Return Water Requirements of the subject volume being treated by the Present Method 10 include the necessary characteristics of being: (1) Particle Free; (2) containing Low dissolved solids, i.e., less than 25 ppm or less than 50 μmhos; and having Preferred Temperatures at less than 70 degrees F. That is, these requirements are necessary as product characteristics of the water volume to be sent back in its recycled state for re-utilization in the hydrolasing process and by the hydrolasing equipment augmenting that process.

In this regard, the particulate must be removed as it is abrasive and damaging to the pump components of the hydrolasing equipment and can block and wear the fine orifices of the spray nozzles employed in such Hydrolasing and washing equipment. The high pressure developed can also cause precipitation of dissolved components as some species have inverse solubilities with respect to pressure and temperature. The pressures involved with hydrolasing and pressure lancing usually vary from between about 1000 psig to about 55,000 psig. Heat generated in compressing the liquid can often generate temperature increases of from about 10 degrees F. to about 50 degrees F. In this regard, the higher temperature also increases the potential of corrosion of the metal surfaces of such systems and equipment; therefore, water with minimal silica, sulfate, carbonate and chloride is required for the purpose and object of extending the life and wear of the pump and other components of hydrolasing/lancing/concrete shaving equipment.

The Solid/Liquid Separation Subprocess

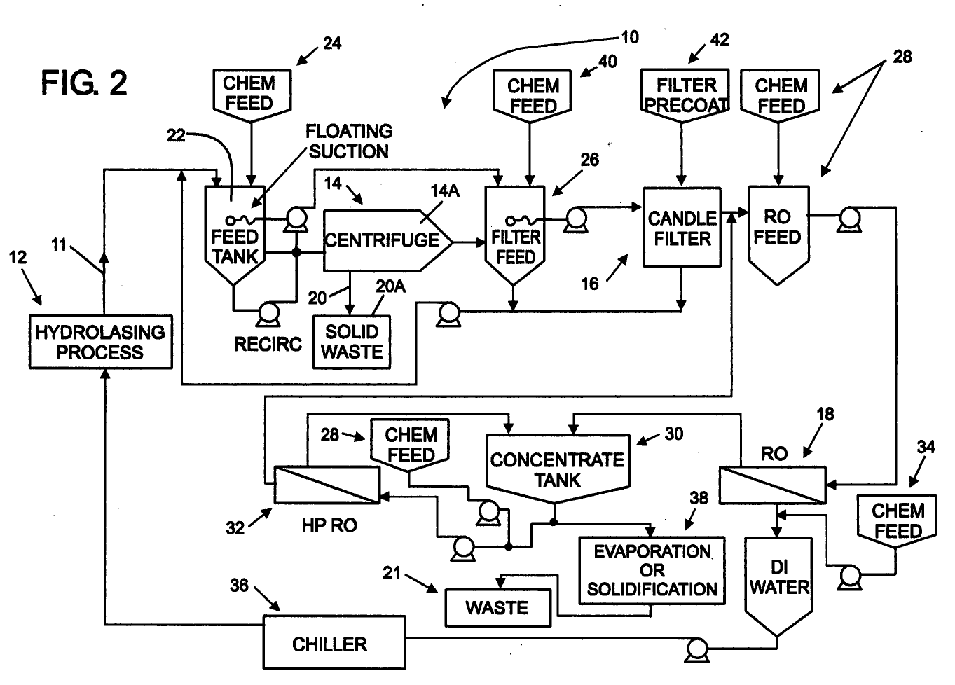

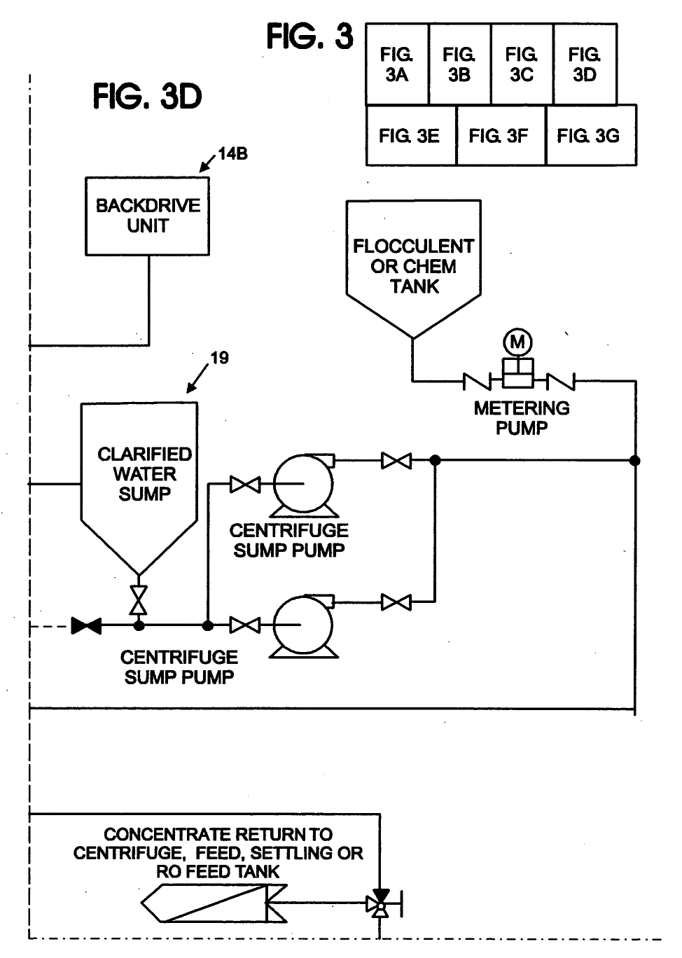

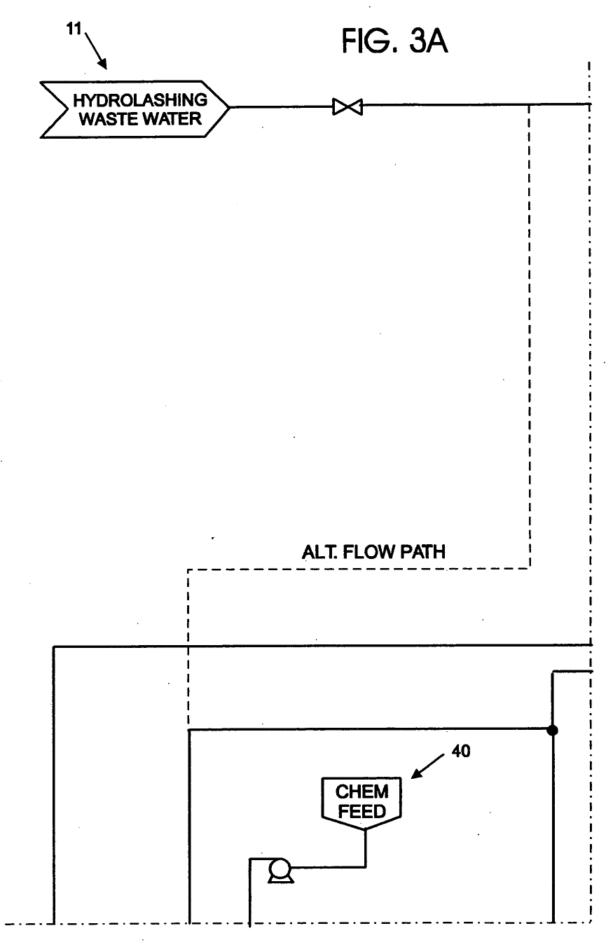

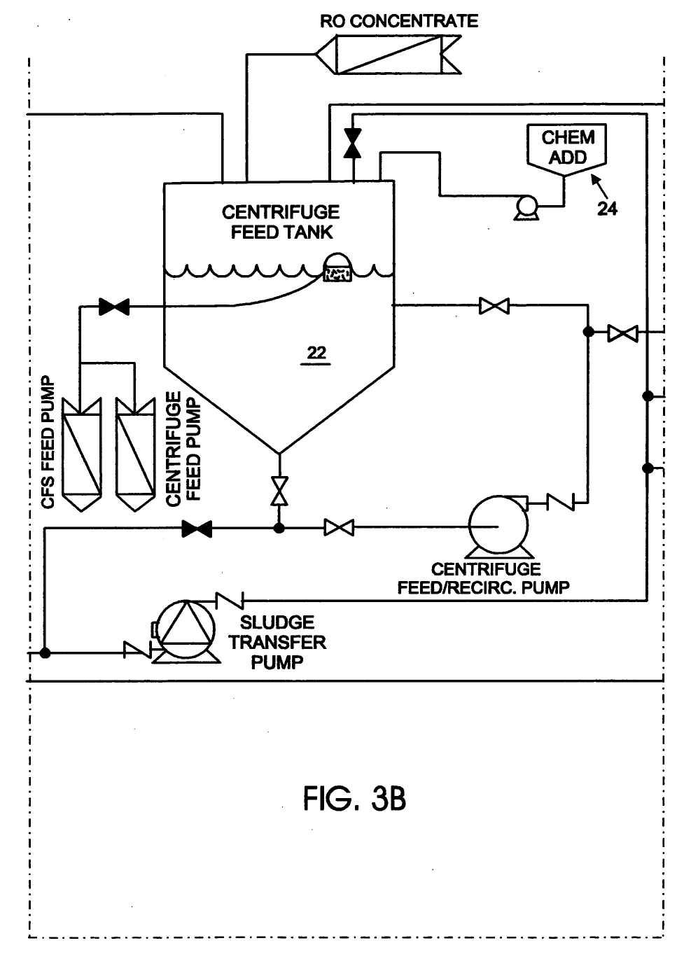

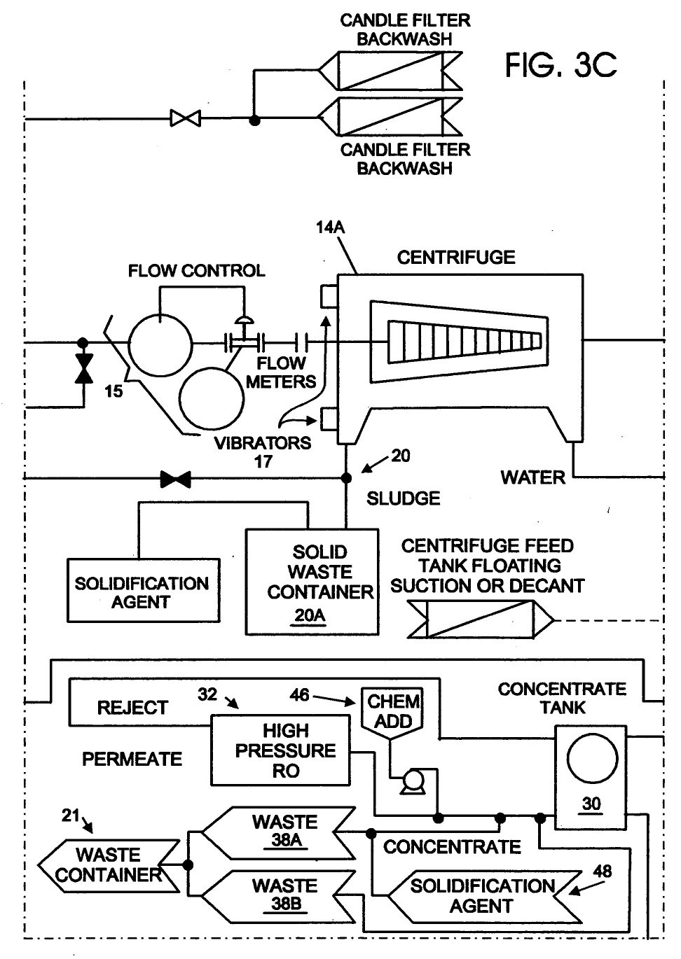

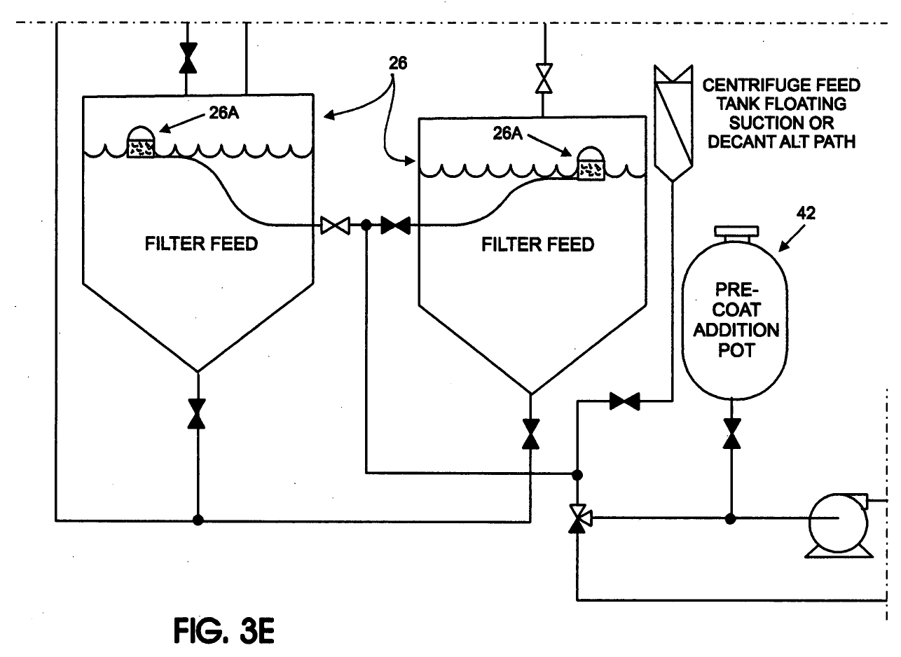

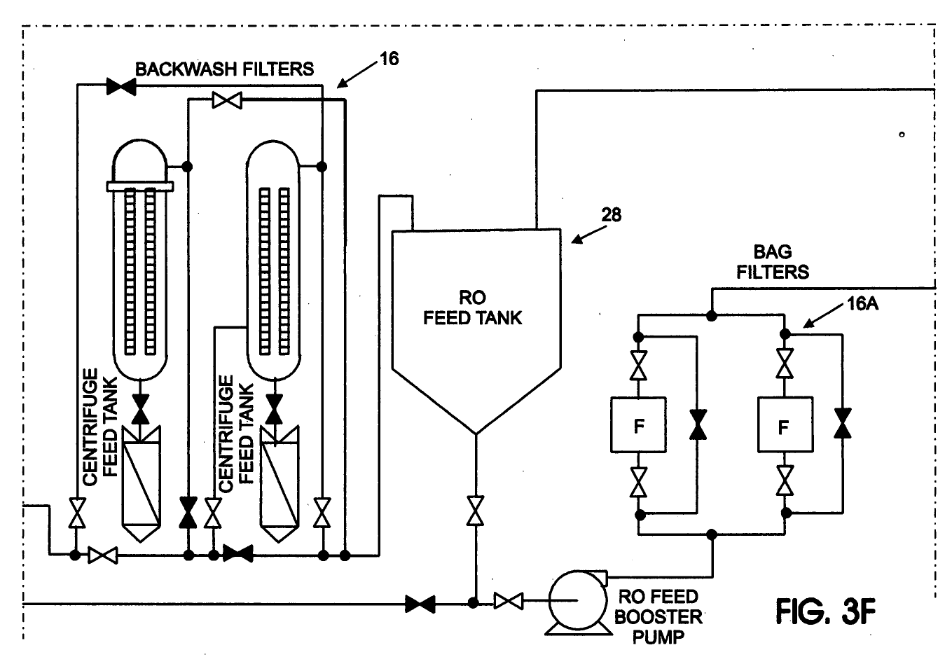

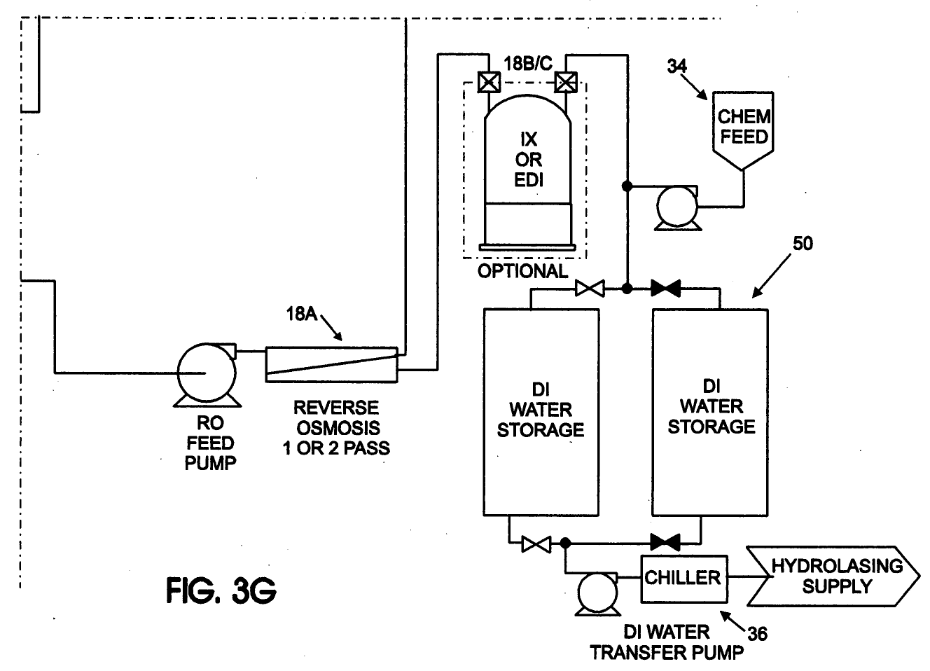

The first critical step in a preferred embodiment of the Recycle Process 10 is Separating Of The Particulate From The Wastewater Stream (or volume) 14. This can be accomplished by utilizing a number of different solid/liquid separation techniques such that this Subprocess 14 is characterized by being subject to remote operation and requiring minimal operational contact by work personnel, so as to minimize exposure to hazardous, toxic or radioactive waste components. The preferred means of accomplishing the Subprocess 14 is by Centrifuge equipment 14A, as illustrated by block and symbol identification in FIGS. 2 and 3. Other techniques which can also be used to augment the Subprocess 14 include, without limitations, the following: (1) Hydrocyclone; (2) Filter Press (Plate and Frame filter); (3) Pressure Filter; (4) Belt Filter; (5) Rotary Vacuum; and (6) V-Chem Oscillating Separator. It should be understood that Centrifuge equipment 14A is preferred when coated surfaces are present or in other instances when centrifuge equipment is deemed appropriate.

The Solid/Liquid Separation Subprocess 14 involves the gross removal of particulate so as to provide a dewatered solid waste, generated therewithin, that is suitable environmentally for burial at most disposal sites. Additional treatment, within the scope of the present invention, may be required to stabilize some solids based on either RCRA requirements or nuclear waste classification. However, the waste generated in the Subprocess 14 must at least approach a dewatered state. The solid waste, thus produced in the Subprocess 14 is deposited 20 into a Waste Container (or Box) 20A for disposal/burial or may be further treated for stabilization; as illustrated generally and symbolically in the flow chart illustrations of FIGS. 1 and 3.

All of the Solid/Liquid separation techniques listed above, or utilized in the Subprocess 14 will or can provide a nearly dewatered waste product from a relatively dilute form in a single operation. Depending upon the character or properties of all of the components of the waste stream 11 some of the referenced techniques have advantages over others in some applications. Each of the techniques; when employed as the augmenting equipment in Subprocess 14; is capable of removing, in most cases more than 99% of the solids; i.e., TSS or Total Suspended Solids; in a single pass; and can remove all of the solids (100%) when utilizing a recycle stream. All of the equipment comprising that utilized in the referenced techniques associated with the Subprocess 14 is also capable of automatic/remote discharge of the solids to a waste container 20A, or conveyor system or submeans for the purpose of minimizing human contact with the solid waste. The relatively clarified water leaving the Subprocess 14, and the equipment, as indicated, utilized therein; is sent on within the Recycle Process 10 of the present invention for further polishing filtration.

Polishing Filtration

The Polishing filter Step 16 is designed for complete removal of the remaining small amounts of solids in the Water Volume 11 remaining after gross, Solid/Liquid Separation 14. This remaining fine particulate, if left untreated, has the potential of fouling or damaging the downstream dissolved solids removal systems; therefore, reducing the useful or effective installation life of the media being utilized. Equipment which can be utilized to augment the Polishing Filter Step 16 includes, without limitation: (1) Candle Filters; (2) Backwashable Filters; (3) Bag Filters; (4) Cartridge Filters; (5) Tubular Cross Flow Filters; and (6) Media Filters. In preferred embodiments of the present invention these filters, or related or equivalent equipment, should be backwashable and precoatable so that the solids can be returned to the Solid/Liquid Separation Step 14 for combining and removal with other solids; and to prevent permanent fouling of the filter surface. The above referenced filter equipment is chosen, specifically, based on the wastewater 11 characteristics, the system size, available space allocation and the job requirements of the dissolved solids removal system.

TDS (Total Dissolved Solids) Removal

The Step within the Present Method 10 of the removal of the Total Dissolved solids/Organics or the TDS Removal Step 18 is important to assure that fouling does not occur in either the high pressure pump and associated piping or the delivery nozzles, due to insolubility or flashing that occurs upon release of the pressure. Dissolved solids, in this regard, are the salts of various metals that are dissolved either from the hydrolased surface or materials deposited on or in the target surface from previous operation. Further, in this regard, Organics are often associated with paints, cleaning agents and other fixative coatings. Within the TDS Removal Step 18, these materials are removed, in preferred embodiments of the present invention, by utilizing the following equipment, based upon specific application and system needs: (1) Reverse Osmosis, (2) Ion Exchange/Absorption Media (18B); and (3) EDI (18C).

The object with the present invention of the TDS Removal Step 18 is to decrease the TDS of the Wastewater or Water Volume 11 to acceptable levels, for recycle or discharge. Contemplated, therefore, within the scope and spirit of the invention, is removal of both dissolved ionic materials and organic species. Herein, therefore, is one of the objects of the present invention, where all of the steps and associated equipment are designed to concentrate the contaminants being dealt with in the Water Volume 11 so that economical or cost effective recycle and disposal is possible.

Where Reverse Osmosis equipment is utilized in preferred embodiments herein to augment TDS Removal 18; such Reverse Osmosis Equipment utilizes membranes to concentrate TDS and provide a generally and relatively TDS free permeate. The concentrate stream in this regard is a small percentage of the permeate flow or the Water Volume 11. The concentrate can, in preferred embodiments, be recycled to further build concentration or can be sent to a higher pressure RO (Reverse Osmosis Unit of equipment on line) for further concentration, with the permeate being returned to the main system for recycle. The RO unit, as depicted and illustrated schematically and symbolically in the flow chart drawings FIGS. 2 and 3; will perform in the present invention to concentrate both inorganic and organic constituents.

Where, in other preferred embodiments hereof, as a part of TDS Removal 18, ion exchange media is utilized, the TDS is loaded onto the IX resin, as optionally illustrated in FIG. 3. Once expended, the media is transferred to a disposal container for transport, burial and/or disposal and/or regeneration. The Organics, or organic constituents, encountered in a Water Volume 11 can, within the spirit of the present invention, require other absorption media equipment to be utilized in augmentation of Step 18 for removal thereof. Additionally, small amount of Organics can be removed by Anion Resin.

Additional Alternative Preferred Embodiments of the Present Invention Utilizing:

The Feed Tank 22 (FIG. 2) provides a buffer area for collection of slurry from wastewater 11 prior to, during, and after batch processing. The feed tank 22 in preferred embodiments is used as a method to maintain a slurry for easy feeding of a consistent stream to the equipment of the solid/liquid Separation Subprocess 14. The feed tank 22 is also utilized as a separation device by permitting settling to occur and using a floating suction to remove the most clarified water, by passing the gross separation equipment of solid Liquid Separation 14, to be sent for further chemical treatment and polishing filtration.

Pre-Solid/Liquid Separation Chemical Treatment

The feed tank 22 is utilized for addition of chemical additives for pH adjustment, precipitation, flocculation, or coagulation. Dissolved metals can be precipitated by the addition of chemicals such as phosphates, apatates and bifluorides. Therefore, in such instances, a selective Separation Chemical Treatment Step 24 (FIG. 2) is required; in that some chemicals may interact with some of the solids present, causing excessive consumption and dissolution of some of the solid material.

The advantages for the use of such precipitants is the reduction in potential down stream scaling, increased ability to concentrate Reverse Osmosis 18-concentrates (i.e., reduced liquid volume for disposal), and a decrease in exchange media required to provide DI type water (See FIGS. 2 and 3).

Further, flocculant additions can aide in the efficiency of the centrifuge or other S/L (Solid/Liquid) separation devices utilized in the Present System 10. IN this regard flocculants or coagulants cause the fine particulates to stick together and to thereby form larger particles; which, then, are more easily separated by devices or equipment employed in the present invention. Additionally, pH adjustment can improve separation and provide or minimize precipitation of some of the dissolved components.

Use of Centrifuge Equipment in S/L Separation

The specific employment of Centrifuge equipment in S/L Separation 14, in preferred embodiments of the Present System 10 is important because of its, often, superior ability to handle most any solid type of material for removal. The very high gravitational forces generated in using such equipment cause separation to occur in an accelerated time frame. Characteristics of such equipment in so far as the scrolling nature of solid removal, allow such equipment to be forgiving (or functionally tolerant) with regard to sticky materials, which are simply extruded through available discharge portals in this equipment. Further, the solid bowl type centrifuge, used in preferred embodiments herein, will also separate and discharge materials even lighter than water by removing them onto the ‘beach’ of such equipment in the solids discharge.

In many applications of preferred embodiments of the Present System 10, Centrifuge equipment utilization offers advantages over filter press, belt filter and pressure filter equipment in its ability to handle very sticky materials without fouling a membrane, as no membranes are required in this process with Centrifuge utilization in S/L separation 14.

Also, in these applications, the Centrifuge has advantages over hydrocyclone equipment for separation of a wide range of size distribution; and this distribution can change over time without significantly affecting the recovery or flux rate. Further, the flow rate through a centrifuge can be varied from zero to the maximum rate designed for the unit with only minimal effects on the recovery rate. The hydrocyclone equipment, when employed in S/L Separation 14 of the recycle Process 10, must be maintained at the design flow rate or recovery will be decreased at lower flow rates, very significantly. Hydrocyclones are sensitive to the particle size distribution and the flow rate through the unit. The hydrocyclones are required to be sized based on the fine sized particles that must be recovered. The density of the particles being fed to a hydroclone is a major factor in the separation efficiency; whereas, the centrifuge equipment, with its high ‘G’-Forces, is less sensitive as long as a difference does exist. Coatings are potentially fouling to surfaces of hydrocyclones. The centrifuge equipment, as employed in the Present Method 10, in preferred embodiments, is much more independent of all of the above factors; and is the preferred equipment utilization in the Subprocess 14 herein, except as provided herein in special selected jobs or applications.

Hydrocyclone (Hydroclone) Utilization in Step 14

When all of the solid material in a Wastewater Feed 11 has a significant density difference in relation to the liquid therein, then utilization of the hydrocyclone equipment in Step 14 is more cost effective, utilizes less space (or is much smaller in size), easier to operate, and has no moving parts that may fail and, therefore, an improved mechanical advantage in relation to other applicable equipment for such jobs. It provides a continuous process where a high solids slurry is the final product within the subprocess 14. In such a case, this may require either additional dewatering or the provision for some chemical additions to provide a product suitable for burial, environmentally.

Filter Press Utilization in Step 14

A filter press can be utilized as the augmenting equipment as a S/L device in Solid/Liquid Separation 14 of the present invention when the solids removed from the water volume 11 are, in themselves, easily discharged from a filter membrane and will cause no significant flux degradation during a normal processing cycle. The filter press in preferred embodiments, is remotely operated and is effective at removing essentially, or substantially, all of the particulate from the Stream 11. In some cases, depending on the job at hand, the polishing filter may be eliminated if, with regard thereto, no chemical treatment after gross, S/L Separation 14 is required. Automatic scraper and solids collection devices or equipment are available and utilizable in augmentation of Step 14 to collect and deposit the solids into a waste box 20A for disposal. The filter presses, in their application as part of Step 14, call for less capital investment or cost and have minimal moving parts. In their application as part of the present process 10, slurry is pumped into each filter chamber until such a chamber is filled or flux rate drops to unacceptable flow rates. The filter frame is expanded and solids are discharged by virtue of applicable gravity, then blown out with air, or scraped from the surface. This cycle is then repeated. The disadvantages to such utilization and technique in this regard is that fine and sticky solids, when encountered, cause blinding of the membranes that cause flux rate reduction; which, when so encountered, may require special cleaning to recover the flux rate. Also, discharge of the solids may be difficult for sticky materials encountered. The process in this regard is batch-oriented such that the water flow, or flow of stream 11, is interrupted during the solids removal.

Post Gross S/L Separation Chemical Treatment (26) (FIG. 2)

Precipitation of dissolved metals (for example calcium, magnesium, iron, etc.) is best done, in preferred embodiments of the invention and process, after gross solids have been removed in Step 14, because many of the potential chemical precipitants may also interact with such solids (for example, concrete fines), thus reducing their efficiency. The Treatment 26 at this point permits the removal by the polishing filter without significant loss of chemical due to interaction with the solids, themselves. Precipitation of Ca, Mg, Fe and other substances or materials prevents scaling of the membranes during reverse osmosis augmentation in Step 18 by eliminating the problematic metals. The addition of chemicals 40, such as appatites and bifluorides, effectively removes these metals, passing through the Process 10, as a precipitate.

Backwashable Candle Filter Subprocess (16) (FIG. 2)

The utilization of the Backwashable Candle Filter in augmentation of the Polishing Filter Step 16, in preferred embodiments of the Present system and invention 10 (FIG. 2), provides the additional advantage and ability to filter the water to remove the required solids such tat it can discharge the solids back to earlier process steps of the present method 10 for removal by the gross, solid/liquid separation equipment (Step 14), thus resulting in the need for only one solids removal container 20A. The backwashable candle filter equipment has the capability and advantage of utilizing precoat, which provides assured and unfailing release of the solid material being processed. Under some job conditions the hydrolased material in the wastestream 11 is very sticky, and cannot easily be removed from the filter surface. The precoat application and utilization in this equipment provides improved filtration down to lower micron dimensions and the ability to release material such as epoxy paint; which, in and of themselves, would have properties causing them to tend to stick rather permanently to filtration surfaces.

pH and Anti-Scalent Addition (28) (FIG. 2)

As dissolved constituents in water reach their solubility limits in the feed water or Wastewater Feed 11, or while passing through the Reverse Osmosis Unit 18A of Step 18; the potential for scaling of the RO membranes becomes more likely to moving into the problem-stage. Scaling of the membranes can either be temporary or permanent, depending upon the chemical constituents. Both situations reduce the flux rate of the membranes, thus reducing the effective processing capacity, and actually increasing the possibility of additional scaling as the operating pressure is increased in an attempt to maintain process flow rates. In this regard, solubilities are often dependent upon pH as the chemical form changes with pH. Controlling pH is therefore a way of controlling scaling of the membranes and permitting further concentration of RO concentrates. The feed to the RO equipment 18A is thus controlled to maximize the solubility of the potential scaling components. For example, maintaining the pH below ‘7’ will convert carbonates and bicarbonates to carbon dioxide that is completely soluble, and forms no precipitates under normal conditions. Above pH 7, and particularly above pH 8.5 the calcium and magnesium carbonates that are typically found in water are highly insoluble. Anti-Scalant Addition 28 is another method, and subprocess with the present method 10, of dealing with precipitate prevention or delay, as part of the preferred embodiments of the present invention. Anti-Scalants slow down the precipitation kinetics; therefore, permitting the concentrate to clear the membrane system before precipitation occurs; or, in some cases, it may raise the solubility limits by forming more soluble complexes.

Reverse Osmosis (18) (FIG. 2)

Utilization of Reverse Osmosis Equipment 18A in augmentation of TDS Removal 18 is the preferred method and subprocess for removing and concentrating dissolved material and organics in water, in order to provide near DI, or near DI quality water, for recycle or discharge. When sufficiently concentrated, the concentrate volume is smaller than ion exchange, or other exchange media, for disposal; therefore, reducing costs and storage space.

Concentrate Tank (30) (FIG. 2)

The concentrate tank, and the step of such storage, 30 is used to store primary RO concentrate until either enough of such concentrate is available for transfer to a disposal container or until sufficient concentrate is available for operation of the high pressure RO Unit 18A, for obtaining additional concentration. The permeate of the high pressure RO equipment 18A is recycled to the main processing system for recycle; and the reject is either returned for additional processing or sent on to evaporation or solidification.

High Pressure RO (32) (FIG. 2)

In order to concentrate the reject from the main Reverse Osmosis Equipment, as a part of Step 18, a higher pressure RO is required to overcome the osmotic pressure of the concentrate. The normal RO has pressure limits of approximately from about 400 psig to about 600 psig. This limits concentration of concentrate to effectively less than 20,000 μmhos before significant reduction in flux rate occurs. By increasing the maximum pressure to from about 900 psig to about 1200 psig, or more, the concentration can be increased effectively to 50,000 μmhos. This effectively decreases the volume of concentrate by more than half. Concentrate volume reduction is important in the present invention and process 10, in preferred embodiments thereof, as this must be disposed at a relatively high cost; or, sometimes, stored when a disposal site is not available.

Post RO Chemical Treatment (34) (FIG. 2)

The pH must be maintained within specific limits to minimize corrosion to downstream high pressure equipment. Either periodic or continuous adjustment is desired to maintain the pH within these necessary limits.

Cooling (36) (FIG. 2)

The temperature limitations on the high pressure pumps require that the feed water 11 be cooled if the temperature of the water exceeds the manufacturer's specification. Water temperature above the recommended levels causes excessive wear on pump sealing components of the equipment employed in the present process 10.

Additional Included Aspects or Elements Of Preferred Embodiments Of The Present Invention

Further included within the scope and spirit of the Present Method and Process 10 of the present invention, are the following:

Vibrators (17) are used to aide the discharge of solids from the Centrifuge Discharge chute. Sticky material builds up in the discharge chute and can cause blockage if not disengaged.

Flow control (15) to the Centrifuge is maintained using feedback from a flow meter to a control valve or to control the speed of the pump through a variable frequency drive motor on the pump.

Solidification Agent (48) is added to RO concentrate to change concentrate from a liquid to solid form to meet burial or storage requirements.

Evaporation (38B) is utilized to remove water from concentrate to form a dry precipitate as an alternative to solidification.

Solidification (38A) utilizes the addition of chemical agents to chemically or physically bind water to produce a dirt-like material suitable for burial or storage.

DI water storage tanks (50) are utilized as storage devices to provide a continuous means for supplying water to the hydrolasing or lancing equipment or process; or other decontamination equipment, means or possesses herewithin.

Clarified water sump (19) collects water from centrifuge (centrate) for periodic or continuous transfer to polishing filters (26). Size of sump can vary from a few gallons to greater than 1000 gallons.

Centrifuge Backdrive (14B) equipment is used to provide continuous or periodic removal of solids from centrifuge (14) through scrolling or similar device.

Floating suction (26A) or decant line is used to remove partially clarified water that is fed to the polishing filter (16).

Bag Filters (16A) are both secondary filtration following backwash filters or as primary polishing filters in case of a bypass condition.

Wastewater (11) feed for this process could come from other decontamination processes besides hydrolasing (12). The wastewater generating process may also include pressure washing, lancing, scabbling (pins driven down by air to cause a chisel-like action or affect), concrete shaving and similar processes utilizing water.

### EXAMPLES OF EQUIPMENT USAGE, AMONG OTHER TYPES EMPLOYABLE, IN PREFERRED EMBODIMENTS OF THE INVENTION

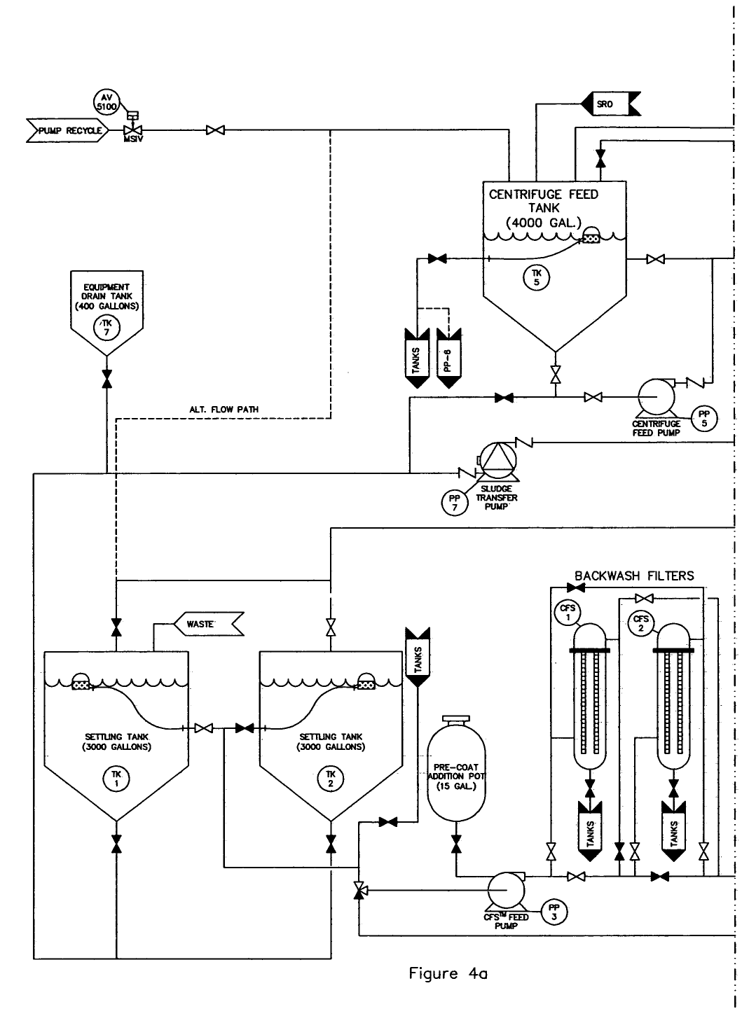

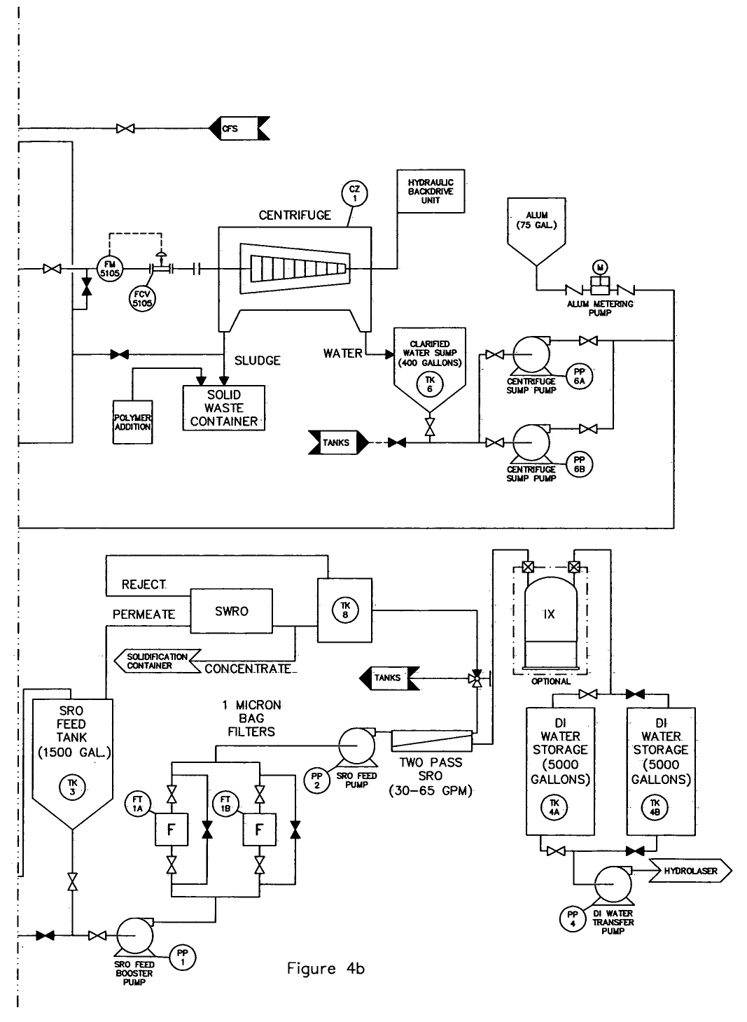

The reader is referred to FIG. 4 as to letter-numbering of specific equipment members or elements of the invention, in addition to previous reference numbering utilized herein. Embodiments of the present method 10 preferably utilize the following System Skids and Equipment, although many different and diverse types of equipment can be utilized to accomplish the novel steps and sub-processes of the present invention within the scope and spirit thereof:

Centrifuge System (14A):

The Centrifuge System Skid contains the Centrifuge (CZ-1), Centrifuge Feed Pump (PP-5), Centrifuge Sump Pumps (PP-6A & 6B), Clarified Water Sump (TK-6), Sludge Transfer Pump (PP-7), Equipment Drain Tank (TK-7), and the Centrifuge System Main Control Panel (CZ-MCP).

The Centrifuge Feed Tank (TK-5) is mounted independent of the Centrifuge System Skid. This equipment is utilized in Step 14.

Candle Filter System (CFS™) Utilized In Step 16):

The CFS™ Skid contains the CFS™ Back-Washable Filters (CFS-1 & 2), CFS™ Feed Pump (PP-5), CFS™ Pre-Coat Pot, and the CFS™ System Main Control Panel (CFS™-MCP).

Settling Tanks (TK-1 & 2) are mounted independent of CFS™ System Skid.

Spiral Reverse Osmosis (SFO) System Utilized in Step 18:

The SRO Skid contains the SRO Feed Booster Pump (PP-1), SRO Feed Pump (PP-2), Spiral Reverse Osmosis Modules & Membranes, SRO Sample Sink, and the SRO Main Control Panel (SRO-MCP).

The SRO Feed Tank (TK-3) and the SRO Pre-Filters (FT-1 & 2) are mounted independent of the SRO Skid.

DI Water Supply System:

The DI Water Supply System is comprised of the DI Water Storage Tanks (TK-4A & TK-4B), DI Water Transfer Pump (PP-4), and the DI Water Main Control Panel (DI-MCP).

Optionally an Ion Exchange Vessel (IX-1) may be used to further polish the Dl Water.

Centrifuge System (14) (14A)—Step 14, Centrifuge Equipment 14A:

The Centrifuge System receives, stores, and processes waste water through the Centrifuge (CZ-1) where the majority of the suspended solids are removed. The sludge is transferred into a CAB where it is treated with an absorbent polymer for disposal. The clarified water is collected in the Clarified Water Sump (TK-6) and transferred by a CZ Sump Pump (PP-6A or PP-6B) to the CFS™ System for additional processing.

Centrifuge Feed Tank (TK-5):

The Centrifuge Feed Tank (TK-5) is an atmospheric, 4400 gallon, vertical, conical bottom storage tank in utilized exemplar equipment. TK-5 stores waste water sent to the system for processing. TK-5 is mounted independent of the Centrifuge Skid in preferred utilizations.

Waste water enters TK-5 through the Main System isolation Valve (AV-5100). Preferably, AV-5100 is a fail closed, air actuated, 1½ inch ball valve and is mounted on the Centrifuge Skid.

TK-5 is agitated by a tangential re-circulation nozzle feed by the Centrifuge Feed Pump (PP-5).

Centrifuge (CZ-1):

The Centrifuge (CZ-1) is a horizontal, cylindrical bowl, clarifying Centrifuge with a variable speed, back-drive conveyor. CZ-1 is nominally capable of clarifying a 25 GPM process stream.

CZ-1 is driven by a 25 HP, 3 phase, 60 hertz, 460 volt, 3600 RPM, TEFC electric motor. CZ-1 motor is powered by a VFD for soft start and variable speed control.

The Back-Drive Conveyor is hydraulically driven by an independent Hydraulic System. Back-Drive Conveyor speed is controlled based on sensed torque. The Hydraulic system has its own independent controls, but is interlocked with the Centrifuge.

It is noted that Engineering Standard, CZ-935-STD-01, which is incorporated herein by reference in its entirety, sets forth more detailed description of the Centrifuge and Centrifuge Back-Drive Hydraulic System.

Centrifuge Feed Flow Control Valve (FCV-5105):

The Centrifuge Feed flow Control Valve (FCV-5105) controls the feed rate to insure optimum efficiency and maximum TSS separation in CZ-1.

FCV-5105 is an air operated, 1½ inch, direct acting, fail shut, control valve. FCV-5105 controls Centrifuge Inlet Feed Flow (FE/FIT-5105) so as to not exceed the operator entered Setpoint between 15 and 25 GPM.

Centrifuge Feed Pump (PP-5):

The Centrifuge Feed Pump (PP-5) is a horizontally mounted, 20 HP electric motor driven, 2″×3″×14″, centrifugal pump. PP-5 is designed to deliver 225 GPM at 45 PSIG, and 75 PSIG at pump shut-off, in preferred embodiments.

The 20 HP prime mover is a 3 phase, 60 hertz, 460 volt, 1750 RPM, TEFC electric motor, in preferred equipment utilization. PP-5 is driven by a Variable Frequency Drive (SIC-5105) to allow for optimizing pump flow rate and operating pressures.

Clarified Water Collection Sump (TK-6):

The Clarified Water Collection Sump (TK-6) is an atmospheric, 400 gallon, vertical, conical bottom storage tank. TK-6 collects and stores the clarified water exiting the Centrifuge (CZ-1).

Centrifuge Sump Pumps (PP-6A & PP-6B):

The Centrifuge Sump Pumps (PP-6A & 6B) are a horizontally mounted, 3 HP electric motor driven, 1″×1.5″×6″ centrifugal pumps. PP-6A & PP-6B are designed to deliver 35 GPM at 50 PSIG, and 75 PSIG at pump shut-off. Twin pumps are provided for redundancy.

The 3 HP prime mover is a 3 phase, 60 hertz, 460 volt, 1750 RPM, TEFC electric motor.

PP-6A & PP-6B are identical to the DI Water Supply Pump (PP-4). Either pump may be used as a replacement in the event of a failure of PP-4.

Equipment Drain Tank (TK-7):

The Equipment Drain Tank (TK-7) is an atmospheric, 400 gallon, vertical, conical bottom storage tank. TK-7 collects and stores equipment drains and overflows from system components and tanks.

Sludge Transfer Pump (PP-7):

The Sludge Transfer Pump (PP-7) is, as equipment utilized in exemplar embodiments of the present invention, a 316SS, 1½″, air-operated-diaphragm (AOD) pump. EPDM elastomers and diaphragms provide excellent chemical compatibility and service life, making it a good choice in equipment utilization in preferred embodiments of the invention. PP-7 is designed to deliver 25 GPM at 25 PSIG, with Service Air furnished at 30 PSIG/25 SCFM.

The Sludge Transfer Pump (PP-7) is used to transfer water and sludge from tank to tank, or from tank to CAB within the system.

Sludge Stabilization:

Sludge that is transferred to the CAB will be treated with an absorbent polymer to remove any incidental water that should remain after the Centrifuge (CZ-1) is utilized.

The Polymer is stored in a 6 Gallon Hopper just above the CZ Fill-Head. A fail-closed, air actuated, ball valve (AV-5112) controls addition.

The absorbent polymer will be added to the CAB before installation, during operations, as required in the present invention, and after processing is complete.

CAB Handling System as Utilized in the Present Invention:

The CAB is placed, by fork truck, directly under the Centrifuge (CZ-1) on a support structure that will properly align the CAB with the Centrifuge (CZ-1) Discharge Chute and CAB Fill-Head in equipment utilized of this nature.

The CAB Fill-Head is attached to the Centrifuge Skid by pneumatic cylinders. These cylinders allow the CAB Fill-Head to be raised and lowered on to and off of the CAB. The Centrifuge (CZ-1) Discharge Chute is connected to CAB Fill Head through a flexible connector.

The Pneumatic Cylinders are controlled by Solenoid Valve (SV-5109). SV-5109 is energized or de-energized by a Maintained Push Button (PB-5109). Position PB-5109B is the Process (Lowered) position and PB-5109A is the Raised position.

The CAB Fill-Head is equipped with a sight glass to allow for observation of operations and level. The sight glass has external washing and drying capability. Remote Visual Level indication is provided by camera and light sources.

The CAB Fill-Head is equipped with a flanged access for close inspections, repairs, or addition of the absorbent polymer during operations.

The CAB Fill-Head is equipped with a Sludge Leveling Device Actuator (AV-5110) to provide for better distribution of waste in the CAB. The Sludge Leveling Devise is driven by a 180° Air Actuator (AV-5110) and linkage system, such that a motion comparable to a windshield wiper is achieved. AV-5110 is actuated by Solenoid Valve (SV-5110). SV-5110 is controlled by Integral Start/Stop Pushbutton/Pilot Light (PB/PL-5110A/B) located on the O/I Screen; such that when running, the PLC will cycle SV-5110 at a frequency selected by a Technician (SP-5110) utilizing the present process and system. Range is 1 to 15 Minutes, Default is 5 Minutes. AV-5110 is interlocked with the CAB Fill-Head such that SV-5110 is deactivated, unless the CAB Fill-Head is in the Process (Lowered) position (PB/PL-5109B is selected/indicated).

Candle Filter System of Step 16:

The Candle Filter System (CFS™) receives, stores, and processes waste water through duplex Candle Filters where the majority of the sub-micron suspended solids are removed. The sludge that is removed by the Candle Filters is routinely blown-down back to the Centrifuge Feed Tank (TK-5) where it will be separated out by the Centrifuge (CZ-1). The filtered water is directed to the SRO Feed Tank (TK-3).

CFS™ Settling Tanks (TK-1 & TK-2):

The CFS™ Settling Tanks (TK-1 and TK-2) are atmospheric, 3000 gallon, vertical conical bottom storage tanks as examples of preferred equipment used in the present method and system. TK-1 and TK-2 store waste water sent to the CFS™ equipment system for processing. TK-1 and TK-2 are mounted independent to the CFS™ Skid.

The TK-1 and TK-2 have floating suctions, which minimize the amount of particulate picked up by the CFS™ Feed Pump (PP-3). Routinely, these tanks will require de-sludging by the Sludge Transfer Pump (PP-7) back to the CZ Feed Tank (TK-5) or the CAB.

Candle Filters (CFS-1 & CFS-2):

Sub-Micron Filtration is accomplished through the present invention's novel use and employment of the method's Candle Filters (CFS-1 and CFS-2). CFS-1 and CFS-2 are proprietary back-washable type filters that are capable of filtering the incoming waste water down to the sub-micron level prior to reaching the Reverse Osmosis System. CFS-1 and CFS-2 are each capable of processing at rates up to about 85 GPM, in desirable utilization in the present invention.

CFS-1 and CFS-2 are pre-coated with special materials that extend run times, remove hardness, and lower the overall micron rating of the filters. In order to maintain the pre-coat on the filter surface when the rest of the system is shut down, a small amount of flow (about 10 GPM) is maintained by recirculating the SRO Feed Tank (TK-3) with the CFS™ Feed Pump (PP-3) through CFS-1 and CFS-2. In accordance therewith, with the Process 10, CFS-1 and CFS-2 should not be operated on waste water without a pre-coat, within the spirit of the present invention.

CFS-1 and CFS-2 are connected through a series of manifolds and valving, such that each filter may be operated in either series or in parallel.

In this regard, normally, CFS-1 and CFS-2 are operated in parallel. However, when it is required to add a filter pre-coat, the filter being coated will be ran upstream of the other filter to insure that proper pre-coating takes place.

CFS-1 and CFS-2 should be blown-down prior to exceeding 25 PSID. During filter blow-down, the applicable filter is isolated and service air is used to pressurize the filter dome. When service air pressure is equalized, the filter's blow-down isolation valve is opened. After one to two minutes the service air is closed. When the filter is depressurized, the blow-down valve is closed. The filter can then be placed back in service after the pre-coat is applied.

CFS™ Feed Pump (PP-3):

The CFS™ Pump (PP-3) is a horizontally mounted, 10 HP electric motor driven, 1″×1.5″×8″ centrifugal pump. PP-3 is designed to deliver 65 GPM at 50 PSIG, and 75 PSIG at pump shut-off, in utilization of this equipment in embodiments of the invention.

The 10 HP prime mover is a 3 phase, 60 hertz, 460 volt, 3600 RPM (nominal), TEFC electric motor, preferably.

PP-3 is powered by a Variable Frequency Drive (VFD). The VFD allows PP-3 to be run at a lower speed during pre-coat and re-circulation evolutions.

Pre-Coat Addition Pot:

The Pre-Coat Addition Pot is a 15 PSIG. 10 gallon, vertical, conical bottom addition pot.

When required, pre-coat materials will be slurried and added to the Pre-Coat Addition Pot. Once the liquid is added, the addition pot is secured and pressurized to 5 PSIG.

A sight glass and isolation valve is provided for starting and securing flow of pre-coat into the suction line of the CFS™ Feed Pump (PP-3).

Spiral Reverse Osmosis (SRO) System as Utilized in Step 18 of the Invention:

The SRO System is a rugged, low-cost, two pass, spiral-wound, RO membrane system capable of producing from about 1 (one) to about 50 μmhos DI grade water. In preferred embodiments, a second pass is not preferably used in most project-applications of the present invention. The Spiral Reverse Osmosis System (SRO), as employed in the present Method 10, preferably uses the following equipment:

SRO Feed Tank (TK-3):

The SRO Feed Tank (TK-3) is an atmospheric, 1500 gallon, vertical, conical bottom storage tank. TK-3 accepts waste water sent from the CFS™ system employed for processing by the SRO. TK-3 is mounted independent to the SRO Skid.

SRO Feed Booster Pump (PP-1):

The SRO Feed Booster Pump (PP-1) is a horizontally mounted, 5-HP electric motor driven, 1″×1.5″×6″ centrifugal pump. PP-1 is designed to deliver 50 GPM at 50 PSIG, and 75 PSIG at pump shut-off. The 5 HP prime mover is, preferably, a 3 phase, 60 hertz, 460 volt, 3600 RPM (nominal), TEFC electric motor.

The SRO Feed Booster Pump (PP-1) receives suction head from the SRO Feed Tank (TK-3). PP-1 is used to provide adequate Net Positive Suction Head (NPSH) to the SRO Feed Pump (PP-2) after pre-filtration by the SRO Pre-Filters (FT-1A and FT-1B).

SRO Pre-Filters (FT-1A & FT-1B):

The SRO Pre-Filters (FT-1A and FT-1B) are, preferably, standard 8″×30″, 1 micron, bag type filters. FT-1A and FT-1B serve as back-up filtration to the CFS™ subsystem to prevent RO membrane fouling in the event of a CFS™ failure.

The SRO Pre-Filters (FT-1A and FT-1B) can be bags constructed of polypropylene, polyethylene, or other materials. FT-1A and FT-1B are equipped with 2″ Male Cam-Lock style inlet/outlet ports, 2″ inlet, outlet, and bypass isolation valves, ½″ vent valve and ¾″ drain valve for maintenance activities. Maximum differential operating pressure is from about 15 to about 25 PSID.

SRO Feed Pump (PP-2):

The SRO Feed Pump (PP-2) is a horizontally mounted, 40 HP electric motor driven, 3″×3″×5″, 24 Stage, centrifugal pump. PP-2 is designed to deliver 65 GPM at 500 PSIG, and 650 PSIG at pump shut-off. The 40 HP prime mover is, preferably, a 3 phase, 460 volt, TEFC electric motor.

The SRO Feed Pump (PP-2) receives its suction head from the SRO Feed Booster Pump (PP-1) and increases the pressure to overcome the Osmotic Pressure of the water feeding the RO Unit.

PP-2 is interlocked with PP-1 and the Inlet Feed Pressure (PIT-5001). PP-1 must be running or Inlet Feed Pressure (PIT-5001) must be greater than 75 PSIG before PP-2 can be started. If PP-1 is not required, PP-1 Motor Starter integral disconnect should be tagged in the Off position and PP-1 shaft should be locked.

Spiral Reverse Osmosis Unit (SRO or RO Unit):

The Spiral Reverse Osmosis Unit (SRO) consists of two passes. Both the first and second passes are fitted with about three (3) to about eight (8) inch (″) nominal ID modules in series. Each membrane module holds four (4) polyamide thin film composite membranes in series, preferably. The SRO membranes have a maximum operating temperature of about 122° F. and operating pressure of about 600 PSIG.

During operation semi-permeable, polyamide material, which the membranes are made of, allows the passage of water and some small non-ionic molecules while rejecting large ionic molecules when pressure is applied to the feed side of the membrane. The osmotic pressure of the feed solution must be exceeded to force the flow of water from the concentrate/feed side to permeate side of the membrane. The resultant products of this subprocess are permeate product and concentrate reject. The rate at which permeate is produced is related to the tightness of the selected membranes, feed pressure, and the feed solutions osmotic pressure.

As permeate is produced, the concentration of the ions increase in the concentrate. Care must be taken to not exceed solubility limits or scaling of the membranes may occur. It must also be noted that the concentration at the membrane surface is significantly higher than that of the bulk solution.

The potential for scaling is primarily determined by the concentration and type of TDS (in particular silica and calcium) and the reject rate. Since TDS concentration and type cannot be controlled, reject flow rate is controlled to minimize scaling, and to ensure that efficient operation of the SRO is maintained.

Particulate fouling is another situation that can be detrimental to the membranes. Particulate fouling occurs when solids are deposited on the membrane walls or spacer mesh, when proper pre-filtration is not maintained and turbulence in the module is not great enough to scour the solids off.

As previously set forth, RO membrane rejection efficiency is about 97 to about 99 percent per pass (for most constituents); therefore, a two pass unit may be required to obtain 99.99 percent removal of the constituents. The first pass reject (about 1 to about 5 percent feed volume) is discharged for further concentrating. The SRO first pass permeate, however, may be fed to the second pass for polishing. The second pass reject is returned to the SRO feed for reprocessing. The second pass permeate is then sent to the DI Water Storage Tank (TK-4). The water leaving the second pass may have to go through an Ion Exchange (IX) polishing bed to obtain the final DI Grade Water desired.

Inter-pass pH adjustment may be required in obtaining low conductivity out of the second pass. This is due to the conversion of CO sub. 2 to CO sub. 3, which is easily rejected by the membrane. A metering pump and high purity pH analyzer is employed to control pH in preferred embodiments.

SRO Process Control Valves (PCV-5001, FCV-35 and FCV-60)

The SRO Process Control Valves (PCV-5001, FCV-35 and FCV-60) control flow rates and pressures to insure optimum efficiency and maximum TDS rejection.

PCV-5001 is an air operated, 1½″, direct acting, fail shut, control valve. PCV-5001 controls overall subsystem throughput based on: (1) Maintaining SRO Feed Tank Level (LT-5203) at a Technician selected setpoint; (2) Not allowing SRO Inlet Feed Flow (FI-5003) to exceed 70 GPM, or (3) Not allowing RO Feed Pressure (PIT-5003) to exceed 590 PSIG.

FCV-35 is a 1″, manually operated, globe valve in preferred equipment. FCV-35 controls first Pass RO reject flow based on the Technician's setting. Setting is based on permitting maximum TDS rejection, at minimum flow, without exceeding a solubility threshold.

SRO Actuated Valves (AV-5007 and AV-5012):

SRO Actuated Valves (AV-5007 and AV-5012) allows for remote bypassing of the second Pass RO Unit, or second Pass permeate recycling at start-up.

AV-7007 permits by-passing of the second Pass RO Unit.

AV-5007 permits recycling of the second Pass RO permeate at start-up.

SRO Main Control Panel (MCP):

The SRO Main Control Panel (MCP) is, preferably, a 36″×48″×12″ NEMA 4 electrical enclosure (though, as throughout herein, others can be used), that contains the SRO Main Feed Disconnect and Fuses, PLC, and SRO motor control components. Operator Interface, Conductivity and pH Analyzers, Emergency-Stop push-button and alarm indications are mounted in the panel door.

Sample Sink:

The SRO Sample Sink is, preferably, provided for easy sampling of the feed water, first Pass Reject, first Pass Permeate, second Pass Reject, and second Pass Permeate.

De-Mineralized (DI) Water System (50):

The DI Water System preferably stores and maintains about 1 μmhos DI Grade Water for distribution, in preferred embodiments, back to the customer, party or organization being served by the present method 10. The DI Water System can incorporate, in preferred embodiments of the present invention, the following equipment:

DI Water Storage Tanks (TK-4A/B/C/D):

The DI Water Storage Tanks (TK-4A/B/C/D) are atmospheric, 2600 gallon, horizontal, oval storage tanks. TK-4A and TK-4C are connected in series without isolation, as is TK-4B and TK-4D, such that two, 5000 gallon storage tanks are formed. These tanks store the DI Water generated by the SRO.

DI Water Transfer Pump (PP-4):

The DI Water Transfer Pump (PP-4) is a horizontally mounted, 3 HP electric motor driven, 1″×1.5″×6″ centrifugal pump. PP-4 is designed to deliver about 35 GPM at 50 PSIG, and about 75 PSIG at pump shut-off. PP-6A and 6B are identical to PP-4, and either may be used to replace PP-4 in an emergency.

The 3 HP prime mover is a 3 phase, 60 hertz, 460 volt, 3600 RPM (nominal), TEFC electric motor. PP-4 is powered through a Variable Frequency Drive (VFD). The VFD controls PP-4 speed such that about 45 PSIG is maintained on the DI Water Supply Header.

Ion Exchanger (IX-1):

In the event the SRO is unable to remove all the TDS, Ion Exchanger (IX-1) may be used to polish the SRO Permeate entering the DI Water Storage Tanks, or the tanks may be re-circulated through IX-1 using PP-4.

IX-1 is, preferably, a 48″ Diameter, 45 CuFt., FRP, Process Vessel rated for about 150 PSIG at about 150° F. IX-1 is filed with mixed bed resin (anion/cation).

DI Water Supply Header:

The DI Water Supply Header provides for various services and supply connections. The header is supplied with a Pressure Regulating Valve equipment, in preferred embodiments, that is set at about 50 PSIG. Any surplus volume is re-circulated back to the DI Water Storage Tanks.

It should be understood by those skilled in the art that a diverse number and various different types of equipment can be utilized to accomplish the teachings of the present method, process and system of the invention. It is, therefore, well within the scope and spirit of the present invention to use many kinds and types of equipment. It will, therefore, be understood that the types and specifications regarding equipment set forth above are merely examples, or some preferred choices of workable equipment, among countless others, which can be utilized within the scope, spirit and breath of the invention.

1. A method for processing wastewater and recycling water, said method comprising the steps of:
providing a wastewater fluid stream from a work source area or equipment area for processing:
separating particulate matter from the wastewater fluid stream;
polishing the wastewater fluid stream;
removing any remaining dissolved solids from said wastewater fluid stream, thereby producing a recycle feed end product; and
conveying the recycle feed end product to the work source area or equipment area for recyclable use and re-utilization in new or initial application cycles thereof.

2. The method of claim 1, wherein the particulate matter of the separating step constitute fine and dissolved solids.

3. The method of claim 1, wherein the work source area or equipment area from which the wastewater fluid stream is provided is a site, area or equipment where a hydrolasing process is being utilized.

4. The method of claim 1, wherein the wastewater fluid stream is a slurry, and the work source area or equipment is a waste barrel containment system.

5. The method of claim 1, wherein the wastewater fluid stream is a slurry and the work source area or equipment is an underwater hydrolasing operation.

6. A method and process for re-cycling a wastewater feed from water cleaning systems and equipment, for return and re-use as an end process product, said method and process comprising the steps of:
accessing a volume or stored amount of hydrolasing or high pressure washing wastewater from the water cleaning systems and equipment;
solid/liquid separating and gross removal of a first particulate from the washing wastewater, said first particulate being substantially a volume of total suspended solids or TSS;
filter polishing the washing wastewater to remove a second particulate, the second particulate being substantially a volume of remaining small amounts of solids existing after said solid/liquid separating step; and
removing total dissolved solids/organics or TDS; thereby completing the steps of said method and process in producing the end process product for the return and re-use by the water cleaning systems and equipment.

7. The method and process of claim 6, wherein said solid/liquid separating step is facilitated by equipment means selected from a group of such means consisting of: centrifuge, hydrocyclone, filter press, filter press/plate and frame filter, pressure filter, belt filter, rotary vacuum, and v-chem oscillating separator; such that a substantially dewatered subproduct waste from a generally dilute form is obtained.

8. The method and process of claim 6, wherein said filter polishing step is facilitated by equipment means selected from a group of such means consisting of: candle filters, backwashable filters, backwashable candle filters, bag filters, cartridge filters, tubular cross flow filters, media filters, and other, primary polishing filters.

9. The method and process of claim 8, wherein said equipment means is backwashable.

10. The method and process of claim 9, wherein said equipment means is precoatable, such that solids can be returned to the solid/liquid separating step for combining and removal with other solids and to prevent permanent fouling of a filter surface.

11. The method and process of claim 6, wherein the step of removing TDS is facilitated by equipment means selected from a group of such means consisting of reverse osmosis or RO, high pressure RO, ion exchange/absorption media and electro deionization or EDI.

12. The method and process of claim 11, additionally comprising, after said step of removing TDS, where high pressure RO equipment means is utilized to facilitate said removing step: the step of storing primary RO concentrate for the purpose selected from a group of such purposes consisting of storing the primary RO concentrate until enough of said concentrate is available for transfer to a disposal container, and storing the primary RO concentrate.

13. The method and process of claim 12, wherein a permeate of the high pressure RO equipment means is recyclably conveyed to the solid/liquid separating step; and a reject volume is selectively sent to one of a group of process areas consisting of an additional processing area, an area for evaporation, and a area for solidification.

14. The method and process of claim 11, wherein, within and a part of the step of removing TDS, a solidification agent is added to a RO concentrate issuing from the RO equipment means, to change the concentrate from a liquid form to a solid form.

15. The method and process of claim 11, wherein, within and a part of the step of removing TDS, water is removed from a RO concentrate to form a precipitate.

16. The method and process of claim 6, wherein, in the step of removing TDS; an ion exchange media or other absorption media is employed, and the TDS is loaded onto a IX resin; and
wherein: once expended, the ion exchange media or other absorption media is transferred to a disposal container means for a purpose chosen from a group of purposes consisting of: transport, burial, disposal, and regeneration thereof.

17. The method and process of claim 7, wherein, within the step of solid/liquid separating, a feed tank is utilized to provide a buffer area for collection of a slurry volume from the wastewater feed prior to, during, and after batch or continuous processing; whereby said feed tank is used to facilitate maintenance of a slurry for substantially easy feeding of a consistent stream to equipment utilized in said step of solid/liquid separating.

18. The method and process of claim 17, wherein the feed tank is utilized for adding chemical additives for the purpose, respectively, of pH adjustment, precipitation, flocculation and coagulation.

19. The method and process of claim 18, further comprising a optional and selective separation chemical treatment step comprising adding a chemical component selected from a group of such components consisting of phosphates, apatates, bifluorides and other components facilitating precipitation of dissolved metals or other solids.

20. The method and process of claim 6, wherein, after the step of solid/liquid separating, additionally comprising the step of post gross solid/liquid chemical treating; said treating comprising precipitation of chemical substances chosen from a group consisting of calcium, magnesium, iron, silica, and other dissolved metals.

21. The method and process of claim 20, wherein chemical agents are employed in said treating step selected from a group consisting of appatites, bifluorides, and other chemical agents facilitating metal precipitation.

22. The method and process of claim 6, wherein pH is optionably and selectively maintained, within selected limits, throughout each of the steps, respectively, of said method and process.

23. The method and process of claim 6, wherein the temperature of the wastewater feed is optionally and selectively maintained, within selected limits, throughout each of the steps, respectively, of said method and process.

24. The method and process of claim 7, wherein vibrator means are employed to aide and facilitate discharge of the TDS in, and as a subprocess element of, the solid/liquid separating step, when sticky and other such materials build up in a discharge chute of the centrifuge equipment means.

25. The method and process of claim 7, further comprising: maintaining flow control to the centrifuge equipment means by selectively choosing, respectively, from using a feedback function from a flow meter to a control valve a part of said centrifuge equipment means; and controlling a speed function component of a pump a part of said centrifuge equipment means, through a variable frequency drive motor on the pump.

26. The method and process of claim 6, further comprising: utilizing at least one deionized storage tank for storing and providing a selectively continuous means for supplying water to the water cleaning systems and equipment.

27. The method and process of claim 26, wherein said water cleaning systems and equipment is selected from a group consisting of hydrolasing equipment, lansing equipment; and other decontamination equipment, means and processes.

28. The method and process of claim 7, wherein the centrifuge equipment means, when employed to facilitate the solid/liquid separating step, communicates with a clarified water sump for collecting water from the centrifuge equipment means for, selectively and respectively, periodically transferring and continuously transferring the water to the filter polishing step.

29. The method and process of claim 8, wherein, partially clarified water that is supplied to the filter polishing step is removed by means selected from a group consisting of a floating suction equipment member, and a decant line equipment member.

30. The method and process of claim 8, wherein a bag filter system is used in relation to a selection from a group of purposes consisting of secondary filtration following use of the backwashable filter, and use as a primary polishing filter in the event of a bypass condition.
